(19) United States
(12) Patent Application Publication
(10) Pub. No.: US 2014/0035962 A1
(43) Pub. Date: Feb. 6, 2014

(54) SIGNAL PROCESSING CIRCUIT, DISPLAY UNIT, ELECTRONIC APPARATUS, AND SIGNAL PROCESSING METHOD

(71) Applicant: Sony Corporation, Tokyo (JP)

(72) Inventors: Gaku Izumi, Tokyo (JP); Seiichiro Jinta, Kanagawa (JP)

(21) Appl. No.: 13/938,341

(22) Filed: Jul. 10, 2013

(30) Foreign Application Priority Data
Jul. 31, 2012 (JP) 2012-170369

(51) Int. Cl. G09G 3/30

(52) U.S. Cl. CPC G09G 3/30
USPC 345/690; 345/76

(57) ABSTRACT

A signal processing circuit performs a correction on a first image signal to generate a noise-like pattern with regularity in an image, and thereby to generate a second image signal. Therefore, even if stripes or luminance unevenness is caused in a display image in the case where the first image signal is input into a display panel, a pattern making the stripes and the luminance unevenness less visible is allowed to be superimposed on the display image. Moreover, a pattern superimposed on the display image is the noise-like pattern with regularity which is obtainable without measuring light emission characteristics of the display panel. Therefore, it is not necessary to measure the light emission characteristics of the display panel to superimpose the above-described pattern on the display image.

### BACKGROUND

The present disclosure relates to a signal processing circuit performing a correction on an image signal and a display unit and an electronic apparatus each of which includes the signal processing circuit. Moreover, the disclosure relates to a signal processing method in which a correction is performed on an image signal.

In recent years, in the field of display units displaying an image, development and commercialization of display units using, as light-emitting devices of pixels, current-driven light-emitting devices, for example, organic EL devices have been proceeded. In the current-driven light-emitting devices, light emission luminance varies according to a value of a current flowing therethrough. Unlike liquid crystal devices, the organic EL devices are self-luminous devices; therefore, in a display unit (an organic EL display unit) using organic EL devices, a light source (a backlight) is not necessary, and accordingly, compared to a liquid crystal display unit using a light source, a reduction in its thickness and higher luminance are achievable.

In such an organic EL display unit, variations in TFT characteristics at the time of manufacturing may cause stripes or luminance unevenness in a display image. In general, to prevent such a display failure, a technique of performing a self-correction (a Vth correction) is typically implemented by a method of driving a TFT (Thin Film Transistor) included in a pixel circuit. However, in reality, the display failure is not sufficiently prevented only by the Vth correction, and in addition to the Vth correction, a μ correction in which a voltage held between a gate and a source of the TFT is corrected based on magnitude of mobility μ of the TFT may be performed (for example, refer to Japanese Unexamined Patent Application Publication No. 2008-148055).

### SUMMARY

In a μ correction, a voltage higher than a voltage used at the time of displaying is used. Therefore, when the μ correction is performed, compared to the case where the μ correction is not performed, a higher-voltage driver IC is necessary, and an amount of heat generated from the driver IC is larger. Accordingly, in mobile apparatuses in which downsizing of a drive system and a reduction in power consumption are necessary, it is necessary to implement a technique of preventing a display failure without performing the μ correction.

Examples of such a technique proposed include techniques described in Japanese Unexamined Patent Application Publication Nos. 2004-212557, 2011-53634, 2009-258302, and 2004-145257. In the Japanese Unexamined Patent Application Publication No. 2004-212557, there is disclosed a technique in which a substrate is rotated at the time of laser annealing to equalize variations in energy density. However, this technique is disadvantageous in that manufacturing cost is increased by an increase in manufacturing time. Moreover, in Japanese Unexamined Patent Application Publication Nos. 2011-53634, 2009-258302, and 2004-145257, there are disclosed techniques of preventing a display failure through measuring light emission characteristics of each individual display panel to generate measurement data and correcting an image signal with use of correction data generated based on the measurement data. However, in these techniques, it is necessary to measure light emission characteristics of each individual display panel. Accordingly, these techniques are also disadvantageous in that manufacturing cost is increased by an increase in manufacturing time.

It is to be noted that stripes and luminance unevenness caused in a display image are not issues specific to organic EL display units. For example, in LED (Light Emitting Diode) display units in which a plurality of LEDs of the order of μm are arranged in a matrix as display pixels, variations in LED characteristics may cause stripes or luminance unevenness in an display image.

It is desirable to provide a signal processing circuit capable of preventing a display failure without increasing manufacturing time, and a display unit and an electronic apparatus each of which includes the signal processing circuit. Moreover, it is desirable to provide a signal processing method capable of preventing a display failure without increasing manufacturing time.

According to an embodiment of the disclosure, there is provided a signal processing circuit performing a correction on a first image signal to generate a noise-like pattern with regularity in an image, and thereby to generate a second image signal.

According to an embodiment of the disclosure, there is provided a display unit provided with a display panel and a drive circuit driving the display panel, the drive circuit including: a signal processing circuit performing a correction on a first image signal to generate a noise-like pattern with regularity in an image, and thereby to generate a second image signal.

According to an embodiment of the disclosure, there is provided an electronic apparatus provided with a display unit, the display unit including a display panel and a drive circuit driving the display panel, the drive circuit including: a signal processing circuit performing a correction on a first image signal to generate a noise-like pattern with regularity in an image, and thereby to generate a second image signal.

According to an embodiment of the disclosure, there is provided a signal processing method including: performing a correction on a first image signal to generate a noise-like pattern with regularity in an image, and thereby to generate a second image signal.

In the signal processing circuit, the display unit, the electronic apparatus, and the signal processing method according to the embodiments of the disclosure, the correction is performed on the first image signal to generate the noise-like pattern with regularity in the image, and thereby to generate the second image signal. Therefore, even if stripes or luminance unevenness is caused in a display image in the case where the first image signal is input into a display panel, a pattern making the stripes and the luminance unevenness less visible is allowed to be superimposed on the display image. Moreover, in the embodiments of the disclosure, a pattern superimposed on the display image is the noise-like pattern with regularity which is obtainable without measuring light emission characteristics of the display panel. Therefore, it is not necessary to measure the light emission characteristics of the display panel to superimpose the above-described pattern on the display image.

In the signal processing circuit, the display unit, the electronic apparatus, and the signal processing method according to the embodiments of the disclosure, even if stripes or luminance unevenness is caused in the display image in the case where the first image signal is input into the display panel, a pattern making the stripes and the luminance unevenness less visible is allowed to be superimposed on the display image; therefore, display failures such as stripes and luminance unevenness are preventable. Moreover, it is not necessary to measure the light emission characteristics of the display panel to superimpose the pattern on the display image; therefore, manufacturing time is less likely to be increased. Thus, in the embodiments of the disclosure, display failures are preventable without increasing manufacturing time.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the technology, and are incorporated in and constitute a part of this specification. The drawings illustrate embodiments and, together with the specification, serve to explain the principles of the technology.

FIG. 1 is a diagram illustrating an example of functional blocks of a display unit according to an embodiment of the disclosure.

FIG. 2 is a diagram illustrating an example of a schematic configuration of a display panel illustrated in FIG. 1.

FIG. 3 is a diagram illustrating an example of functional blocks of a signal processing circuit illustrated in FIG. 1.

FIGS. 4A to 4G are diagrams illustrating examples of an unevenness correction LUT (Look-Up Table) illustrated in FIG. 3.

FIGS. 5A to 5E are diagrams illustrating other examples of the unevenness correction LUT illustrated in FIG. 3.

FIGS. 6A and 6B are diagrams illustrating an example of a method of superimposing the unevenness correction LUT on an input image signal in an unevenness correction in FIG. 3.

FIG. 7 is a diagram exaggeratedly illustrating a first example of an output when an image signal for displaying white is input into an unevenness correction circuit illustrated in FIG. 3.

FIG. 8 is a diagram exaggeratedly illustrating a second example of the output when the image signal for displaying white is input into the unevenness correction circuit illustrated in FIG. 3.

FIG. 9 is a diagram exaggeratedly illustrating a third example of the output when the image signal for displaying white is input into the unevenness correction circuit illustrated in FIG. 3.

FIG. 10 is a diagram exaggeratedly illustrating a fourth example of the output when the image signal for displaying white is input into the unevenness correction circuit illustrated in FIG. 3.

FIG. 11 is a diagram exaggeratedly illustrating a fifth example of the output when the image signal for displaying white is input into the unevenness correction circuit illustrated in FIG. 3.

FIG. 12 is a diagram exaggeratedly illustrating a sixth example of the output when the image signal for displaying white is input into the unevenness correction circuit illustrated in FIG. 3.

FIG. 13 is a diagram exaggeratedly illustrating a seventh example of the output when the image signal for displaying white is input into the unevenness correction circuit illustrated in FIG. 3.

FIG. 14 is a diagram exaggeratedly illustrating an example of an output when an image signal including a stripe-like display failure is input into the unevenness correction circuit illustrated in FIG. 3.

FIG. 15 is a diagram illustrating an example of functional blocks of a driver illustrated in FIG. 1.

FIG. 16 is a diagram illustrating another example of the method of superimposing the unevenness correction LUT on the input image signal in the unevenness correction in FIG. 3.

FIG. 17 is a diagram illustrating another example of the functional blocks of the signal processing circuit illustrated in FIG. 1.

FIG. 18 is a perspective view illustrating an appearance of Application Example 1 of the display unit according to the above-described embodiment.

FIGS. 19A and 19B are perspective views illustrating an appearance of Application Example 2 when viewed from a front side and a back side, respectively.

FIG. 20 is a perspective view illustrating an appearance of Application Example 3.

FIG. 21 is a perspective view illustrating an appearance of Application Example 4.

FIGS. 22A to 22G illustrate Application Example 5, where FIGS. 22A and 22B are a front view and a side view in a state in which Application Example 5 is opened, respectively, and FIGS. 22C, 22D, 22E, 22F, and 22G are a front view, a left side view, a right side view, a top view, and a bottom view in a state in which Application Example 5 is closed, respectively.

### DETAILED DESCRIPTION

Some embodiments of the present disclosure will be described in detail below referring to the accompanying drawings. It is to be noted that description will be given in the following order.

1. Embodiment (Display unit)

2. Modifications (Display units)

3. Application Examples (Electronic apparatuses)

### 1. Embodiment

### [Configuration]

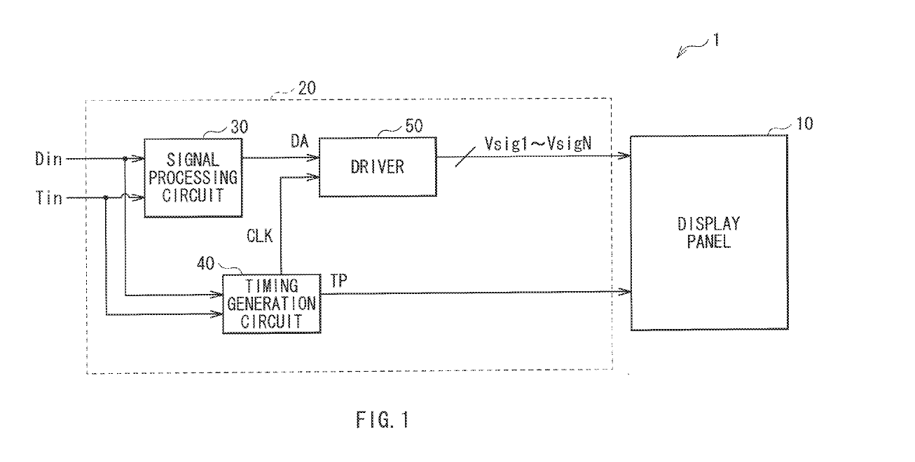

FIG. 1 illustrates a schematic configuration of a display unit 1 according to an embodiment of the disclosure. The display unit 1 includes a display panel 10 and a drive circuit 20 driving the display panel 10 based on an image signal Din and a synchronization signal Tin supplied from outside.

### (Display Panel 10)

The display panel 10 generates image light through electrically altering a polarization state of light by voltage application. The display panel 10 modulates incident light based on input image signals Vsig1 to VsigN to display an image. As used herein, the image signals Vsig1 to VsigN refer to phase-expanded image signals. In the case where the display panel 10 is a panel for color display, the image signals Vsig1 to VsigN may include, for example, image signals VsigR1 to VsigRN corresponding to red pixels, image signals VsigG1 to VsigGN corresponding to green pixels, and image signals VsigB1 to VsigBN corresponding to blue pixels.

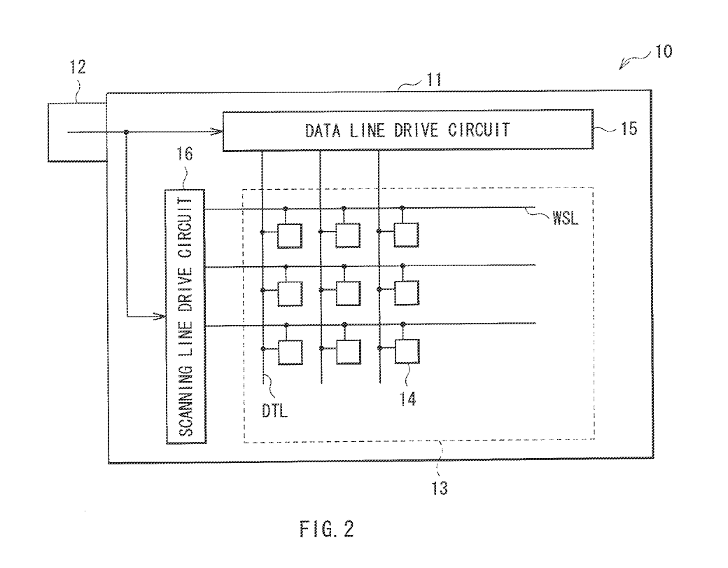

FIG. 2 illustrates an example of a schematic configuration of the display panel 10 illustrated in FIG. 1. The display panel 10 includes, for example, a panel section 11 and a flexible printed circuit (FPC) 12 (hereinafter referred to as “FPC 12”) connected to the panel section 11. The panel section 11 includes, for example, a pixel region 13 in which a plurality of pixels 14 are formed in a matrix, a data line drive circuit 15, and a scanning line drive circuit 16. The panel section 11 displays an image based on the digital image signal Din supplied from outside through actively driving the pixels 14 by the data line drive circuit 15 and the scanning line drive circuit 16.

The panel section 11 includes a plurality of writing lines WSL extending in a row direction and a plurality of signal lines DTL extending in a column direction. The pixel 14 is disposed at an intersection of each signal line DTL and each writing line WSL. The signal lines DTL are connected to an output end (not illustrated) of the data line drive circuit 15. The writing lines WSL are connected to an output end (not illustrated) of the scanning line drive circuit 16.

The data line drive circuit 15 supplies, for example, an analog image signal for one horizontal line supplied from the drive circuit 20 as a signal voltage to the pixels 14. More specifically, the data line drive circuit 15 supplies, for example, an analog image signal for one horizontal line to pixels 14 belonging to one horizontal line selected by the scanning line drive circuit 16 via the signal line DTL.

The scanning line drive circuit 16 selects, for example, the pixels 14 which are to be driven based on a scanning timing control signal supplied from the drive circuit 20. More specifically, the scanning line drive circuit 16 selects pixels 14 belonging to one row as pixels which are to be driven from the plurality of pixels 14 arranged in a matrix through applying a selection pulse to selection circuits (not illustrated) of the pixels 14 via the writing line WSL. These pixels 14 belonging to the one row perform display for one horizontal line in response to the signal voltage supplied from the data line drive circuit 15. Thus, the scanning line drive circuit 16 sequentially performs scanning in a time-divisional manner from one horizontal line to another to perform display on an entire pixel region.

### (Drive Circuit 20)

For example, as illustrated in FIG. 1, the drive circuit 20 includes a signal processing circuit 30, a timing generation circuit 40, and a driver 50.

### (Signal Processing Circuit 30)

The signal processing circuit 30 generates an image signal DA for the display panel 10 based on the image signal Din. The image signal Din is a digital image signal, and is a signal subjected to a predetermined γ correction. In this case, the predetermined γ correction refers to correcting the image signal Din to have a linear relationship between the image signal Din and luminance of a predetermined display unit (a CRT-based television in related art) when the image signal Din is input into the predetermined display unit.

The signal processing circuit 30 performs a predetermined correction on the image signal Din, and outputs the corrected image signal as the image signal DA to the driver 50. The signal processing circuit 30 outputs the image signal DA to the driver 50 at a timing based on a horizontal synchronization signal and a vertical synchronization signal included in the synchronization signal Tin. In this case, as will be described later, examples of the predetermined correction include a linear γ correction (or a reverse γ correction), a γ correction, and an unevenness correction. It is to be noted that the predetermined correction may include any corrections other than the above-described corrections. In this case, the linear γ correction (or the reverse γ correction) refers to generating an image signal (a third image signal) with a linear gamma characteristic through cancelling a gamma correction applied to the image signal Din. The γ correction refers to correcting gradation of an image signal to allow a characteristic of the image signal to have an optimum curve according to a gamma value. It is to be noted that unevenness correction will be described later.

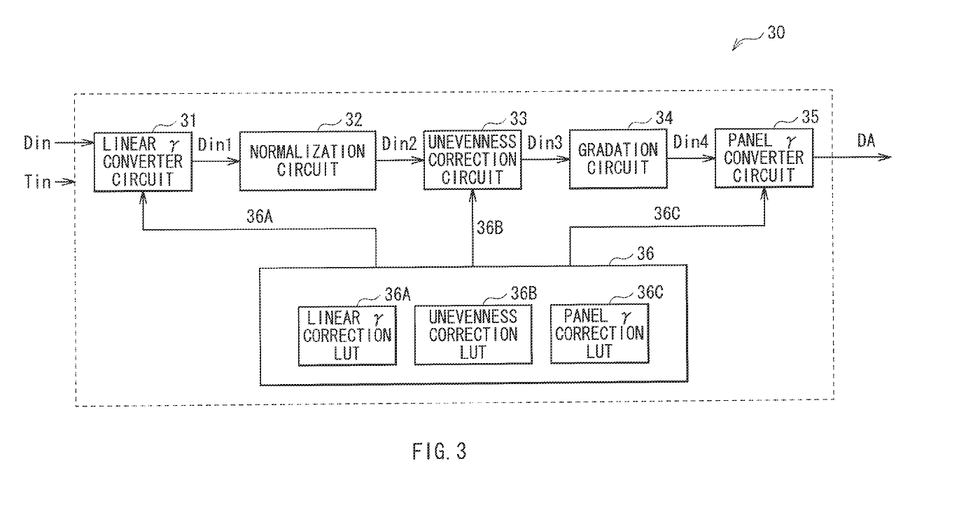

FIG. 3 illustrates a part of an internal configuration of the signal processing circuit 30. The signal processing circuit 30 includes, for example, a linear γ converter circuit 31, a normalization circuit 32, an unevenness correction circuit 33, a gradation circuit 34, a panel γ converter circuit 35, and a storage section 36.

The normalization circuit 32 normalizes an output signal (an image signal Din1) from the linear γ converter circuit 31, and outputs an image signal Din2 obtained through normalizing the image signal Din1. The gradation circuit 34 provides, to an output signal (an image signal Din3) from the unevenness correction circuit 33, gradation information suitable for a D/A converter circuit 52 (which will be described later) in a stage following the gradation circuit 34, and outputs an image signal Din4 obtained through performing a predetermined computation on the output signal (the image signal Din3) from the unevenness correction circuit 33.

The storage section 36 holds, for example, a linear γ correction LUT 36A, an unevenness correction LUT 36B, and a γ correction LUT 36C. The linear γ correction LUT 36A associates an input signal with an output signal to allow the output signal to have a linear γ characteristic. The γ correction LUT 36C associates an input signal with an output signal to allow the output signal to have a γ characteristic complementary to a γ characteristic of the display panel 10. It is to be noted that the unevenness correction LUT 36B will be described later.

The linear γ converter circuit 31 converts the image signal Din into the image signal Din1 with use of the linear γ correction LUT 36A read from the storage section 36. The linear γ converter circuit 31 converts the γ characteristic of the image signal Din into a linear γ characteristic with use of the linear γ correction LUT 36A to output an image signal with the linear γ characteristic as the image signal Din1. The panel 7 converter circuit 35 converts the image signal Din4 into the image signal DA with use of the γ correction LUT 36C read from the storage section 36. The panel γ converter circuit 35 converts a γ characteristic of the image signal Din4 into a γ characteristic complementary to the γ characteristic of the display panel 10 with use of the γ correction LUT 36C to output, as the image signal DA, an image signal with the γ characteristic complementary to the γ characteristic of the display panel 10.

### (Unevenness Correction LUT 36B)

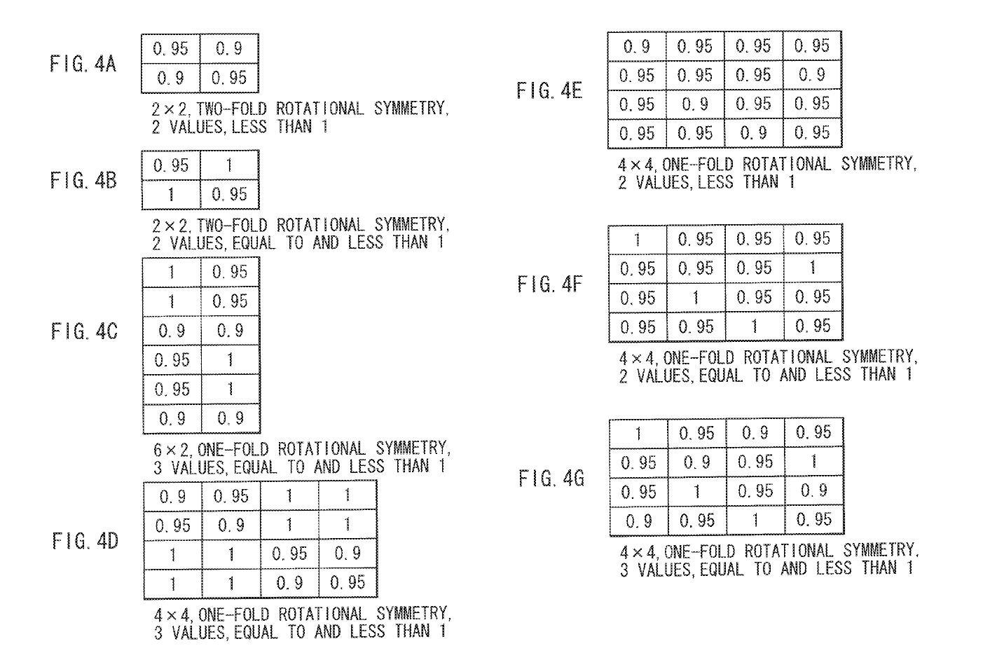

Next, the unevenness correction LUT 36B will be described below. FIGS. 4A to 4G conceptually illustrate the unevenness correction LUT 36B, and more specifically, FIGS. 4A to 4G illustrate states when all correction factors included in the unevenness correction LUT 36B are arranged in a matrix corresponding to an array of pixels 14 in the display panel 10. A plurality of correction factors included in the unevenness correction LUT 36B are luminance ratio values by which luminance expected to appear is multiplied. In this case, the luminance expected to appear refers to luminance of each of light colors emitted from the pixels 14 in the case where the display panel 10 is a panel for color display. Therefore, in the case where the display panel 10 is a panel for color display, one unevenness correction LUT 36B is provided to each of colors of pixels.

In the unevenness correction LUT 36B in FIG. 4A, four correction factors are arranged in a 2×2 array, and are arranged in two-fold rotational symmetry. Moreover, in the unevenness correction LUT 36B in FIG. 4A, the correction factors are classified into two values which are less than 1 (more specifically, 0.9 and 0.95). In FIG. 4A, the correction factors of 0.95 are diagonally arranged, and the correction factors of 0.9 are diagonally arranged. In the case where the array in FIG. 4A is repeatedly arranged in a vertical direction and a horizontal direction, the correction factors of 0.95 are successively arranged in an oblique direction, and the correction factors of 0.9 are successively arranged in an oblique direction. In other words, the correction factors of 0.95 and the correction factors of 0.9 are arranged in a checkered pattern. Therefore, the array in FIG. 4A is designed assuming that specific stripes caused by the display panel 10 extend in the vertical direction or the horizontal direction.

In the unevenness correction LUT 36B in FIG. 4B, four correction factors are arranged in a 2×2 array, and are arranged in two-fold rotational symmetry. Moreover, in the unevenness correction LUT 36B in FIG. 4B, the correction factors are classified into two values which are equal to or less than 1 (more specifically 0.95 and 1). In FIG. 4B, the correction factors of 0.95 are diagonally arranged, and the correction factors of 1 are diagonally arranged. In the case where the array in FIG. 4B is repeatedly arranged in the vertical direction and the horizontal direction, the correction factors of 0.95 are successively arranged in an oblique direction, and the correction factors of 1 are successively arranged in an oblique direction. In other words, the correction factors of 0.95 and the correction factors of 1 are arranged in a checkered pattern. Therefore, the array in FIG. 4B are designed assuming that specific stripes caused by the display panel 10 extend in the vertical direction or the horizontal direction.

In the unevenness correction LUT 36B in FIG. 4C, twelve correction factors are arranged in a 6×2 array, and are arranged in one-fold rotational symmetry. Moreover, in the unevenness correction LUT 36B in FIG. 4C, the correction factors are classified into three values which are equal to or less than 1 (more specifically, 0.9, 0.95, and 1). In FIG. 4C, the correction factors of 0.9 are arranged in two horizontal rows, and blocks including the correction factors of 1 are arranged in an oblique direction with the correction factors of 0.9 in between, and blocks including the correction factors of 0.95 are arranged in an oblique direction with the correction factors of 0.9 in between. In the case where the array in FIG. 4C is repeatedly arranged in the vertical direction and the horizontal direction, the correction factors of 0.9 are successively arranged in the horizontal direction, the blocks including the correction factors of 1 are arranged in an oblique direction and the blocks including the correction factors of 0.95 are arranged in an oblique direction. Therefore, in the case where specific stripes caused by the display panel 10 extend in the vertical direction, the specific stripes are orthogonal to a direction where the correction factors of 0.9 are arranged, and intersect with arrangement of the blocks including the correction factors of 1, and the arrangement of the blocks including the correction factors of 0.95. Therefore, the array in FIG. 4C is designed assuming that specific stripes caused by the display panel 10 extend in the vertical direction.

In the unevenness correction LUT 36B in FIG. 4D, sixteen correction factors are arranged in a 4×4 array, and are arranged in one-fold rotational symmetry. Moreover, in the unevenness correction LUT 36B in FIG. 4D, the correction factors are classified into three values which are equal to or less than 1 (more specifically 0.9, 0.95, and 1). In FIG. 4D, blocks including the correction factors of 0.95 and 0.9 are diagonally arranged, and blocks including the correction factors of 1 are diagonally arranged. In the case where the array in FIG. 4D is repeatedly arranged in the vertical direction and the horizontal direction, the blocks including the correction factors of 0.95 and 0.9 are successively arranged in an oblique direction, and the blocks including the correction factors of 1 are successively arranged in an oblique direction. In other words, the blocks including the correction factors of 0.95 and 0.9 and the blocks including the correction factors of 1 are arranged in a checkered pattern. Therefore, the array in FIG. 4D is designed assuming that specific stripes caused by the display panel 10 extend in the vertical direction or the horizontal direction.

In the unevenness correction LUT 36B in FIG. 4E, sixteen correction factors are arranged in a 4×4 array, and are arranged in one-fold rotational symmetry. Moreover, in the unevenness correction LUT 36B in FIG. 4E, the correction factors are classified into two values which are less than 1 (more specifically, 0.9 and 0.95). In FIG. 4E, while a large number of correction factors of 0.95 are arranged all over the array, the correction factors of 0.9 are scattered sparsely (separately) in array. In the case where the array in FIG. 4E is repeatedly arranged in the vertical direction and the horizontal direction, while a large number of correction factors of 0.95 are arranged all over the arrays, the correction factors of 0.9 are scattered sparsely (separately) in the arrays. Therefore, the array in FIG. 4E is designed assuming that specific stripes caused by the display panel 10 extend in the vertical direction, the horizontal direction, or an oblique direction.

In the unevenness correction LUT 36B in FIG. 4F, sixteen correction factors are arranged in a 4×4 array, and are arranged in one-fold rotational symmetry. Moreover, in the unevenness correction LUT 36B in FIG. 4F, the correction factors are classified into two values which are equal to or less than 1 (more specifically 0.95 and 1). In FIG. 4F, while a large number of correction factors of 0.95 are arranged all over the array, the correction factors of 1 are scattered sparsely (separately) in the array. In the case where the array in FIG. 4F is repeatedly arranged in the vertical direction and the horizontal direction, while a large number of correction factors of 0.95 are arranged all over the arrays, the correction factors of 1 are scattered sparsely (separately) in the arrays. Therefore, the array in FIG. 4F is designed assuming that specific stripes caused by the display panel 10 extend in the vertical direction, the horizontal direction, or an oblique direction.

In the unevenness correction LUT 36B in FIG. 4G, sixteen correction factors are arranged in a 4×4 array, and are arranged in one-fold rotational symmetry. Moreover, in the unevenness correction LUT 36B in FIG. 40, the correction factors are classified into three values which are equal to or less than 1 (more specifically, 0.9, 0.95, and 1). In FIG. 4G, while a large number of correction factors of 0.95 are arranged all over the array, the correction factors of 1 and the correction factors of 0.9 are scattered sparsely (separately) in the array. In the case where the array in FIG. 4G is repeatedly arranged in the vertical direction and the horizontal direction, while a large number of correction factors of 0.95 are arranged all over the arrays, the correction factors of 1 and the correction factors of 0.9 are scattered sparsely (separately) in the arrays. Therefore, the array in FIG. 40 is designed assuming that specific stripes caused by the display panel 10 extend in the vertical direction, the horizontal direction, or an oblique direction.

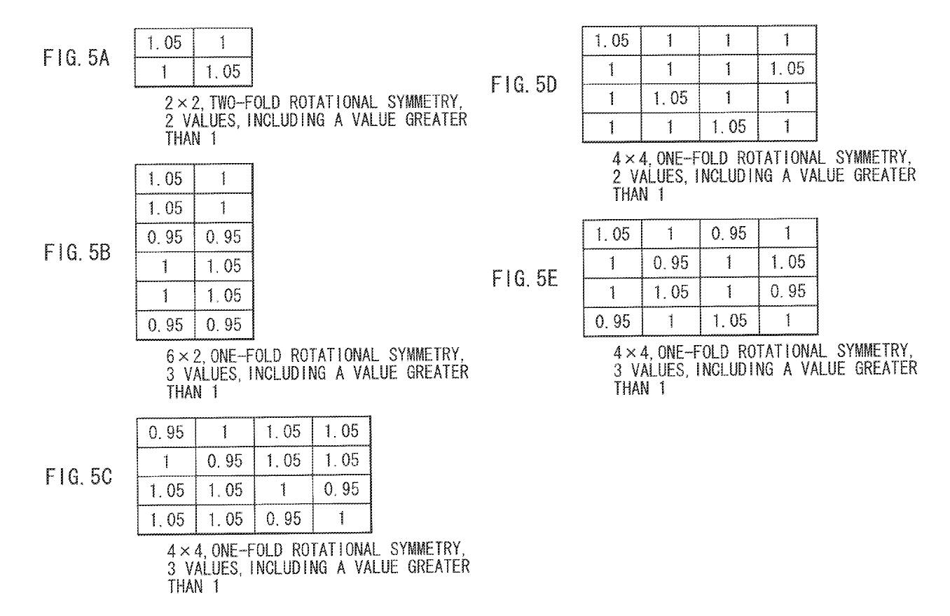

It is to be noted that one kind selected from a plurality of kinds of correction factors included in the unevenness correction LUT 36B may be an integer value greater than 1. In other words, the unevenness correction LUT 36B may include, as correction factors, at least 1 and an integer greater than 1 from among an integer less than 1, 1, and an integer greater than 1. In such a case, a decline in luminance caused by application of the unevenness correction LUT 36B is allowed to be suppressed. FIGS. 5A to 5E illustrate examples of an array of the unevenness correction LUT 36B including an integer value greater than 1 as a correction factor.

In the unevenness correction LUT 36B in FIG. 5A, four correction factors are arranged in a 2×2 array, and are arranged in two-fold rotational symmetry. Moreover, in the unevenness correction LUT 36B in FIG. 5A, the correction factors are classified into two values including a value greater than 1 (more specifically 1.05) and 1. In FIG. 5A, the correction factors of 1 and the correction factors of 1.05 are diagonally arranged. In the case where the array in FIG. 5A is repeatedly arranged in the vertical direction and the horizontal direction, the correction factors of 1 are successively arranged in an oblique direction, and the correction factors of 1.05 are successively arranged in an oblique direction. In other words, the correction factors of 1 and the correction factors of 1.05 are arranged in a checkered pattern. Therefore, the array in FIG. 5A is designed assuming that specific stripes caused by the display panel 10 extend in the vertical direction or the horizontal direction.

In the unevenness correction LUT 36B in FIG. 5B, twelve correction factors are arranged in a 6×2 array, and are arranged in one-fold rotational symmetry. Moreover, in the unevenness correction LUT 36B in FIG. 5B, the correction factors are classified into three values including a value greater than 1 (more specifically, 1.05) and values equal to or less than 1 (more specifically 0.95 and 1). In FIG. 5B, the correction factors of 0.95 are arranged in two horizontal rows, blocks including the correction factors of 1 are arranged in an oblique direction with the correction factors of 0.95 in between, and blocks including the correction factors of 1.05 are arranged in an oblique direction with the correction factors of 0.95 in between. In the case where the array in FIG. 5B is repeatedly arranged in the vertical direction and the horizontal direction, the correction factors of 0.95 are successively arranged in the horizontal direction, blocks including the correction factors of 1 are arranged in an oblique direction, and blocks including the correction factors of 1.05 are arranged in an oblique direction. Therefore, in the case where specific stripes caused by the display panel 10 extend in the vertical direction, the specific stripes are orthogonal to a direction where the correction factors of 0.95 are arranged, and intersect with arrangement of the blocks including the correction factors of 1 and arrangement of blocks including the correction factors of 1.05. Therefore, the array in FIG. 5B is designed assuming that the specific stripes caused by the display panel 10 extend in the vertical direction.

In the unevenness correction LUT 36B in FIG. 5C, sixteen correction factors are arranged in a 4×4 array, and are arranged in one-fold rotational symmetry. Moreover, in the unevenness correction LUT 36B in FIG. 5C, the correction factors are classified into three values including a value greater than 1 (more specifically, 1.05) and values equal to or less than 1 (more specifically, 0.95 and 1). In FIG. 5C, in the array, a block including the correction factors of 1.05 are arranged in an oblique direction, and a block including the correction factors of 1 and 0.95 are obliquely arranged. Therefore, the array in FIG. 5C is designed assuming that specific stripes caused by the display panel 10 extend in the vertical direction or the horizontal direction.

In the unevenness correction LUT 36B in FIG. 5D, sixteen correction factors are arranged in a 4×4 array, and are arranged in one-fold rotational symmetry. Moreover, in the unevenness correction LUT 36B in FIG. 5D, the correction factors are classified into two values including a value greater than 1 (more specifically, 1.05) and 1. In FIG. 5D, while a large number of correction factors of 1 are arranged all over the array, the correction factors of 1.05 are scattered sparsely (separately) in the array. In the case where the array in FIG. 5D is repeatedly arranged in the vertical direction and the horizontal direction, while a large number of correction factors of 1 are arranged all over the arrays, the correction factors of 1.05 are scattered sparsely (separately) in the arrays. Therefore, the array in FIG. 5D is designed assuming that specific stripes caused by the display panel 10 extend in the vertical direction, the horizontal direction, or an oblique direction.

In the unevenness correction LUT 36B in FIG. 5E, sixteen correction factors are arranged in a 4×4 array, and are arranged in one-fold rotational symmetry. Moreover, in the unevenness correction LUT 36B in FIG. 5E, the correction factors are classified into three values including a value greater than 1 (more specifically, 1.05) and values equal to or less than 1 (more specifically, 0.95 and 1). In FIG. 5E, in the array, the correction factors of 1 are obliquely arranged, and a block including the correction factors of 0.95 and 1.05 are obliquely arranged. Therefore, the array in FIG. 5E is designed assuming that specific stripes caused by the display panel 10 extend in the vertical direction, the horizontal direction, or an oblique direction.

Thus, the unevenness correction LUT 36B includes correction factors which are smaller in number than all pixels in the display panel 10. In an array (hereinafter referred to as “first array”) in which all correction factors included in the unevenness correction LUT 36B are arranged in a matrix corresponding to the array of the pixels 14 in the display panel 10, the unevenness correction LUT 36B includes columns which are smaller in number than pixel rows in the display panel 10, and rows which are smaller in number than pixel columns in the display panel 10. Therefore, as will be described later, the unevenness correction circuit 33 sequentially multiplies gradation signals corresponding to all pixels in the display panel 10 by the unevenness correction LUT 36B in groups of gradation signals which are equal in number to the correction factors included in the unevenness correction LUT 36B without collectively multiplying all of the gradation signals.

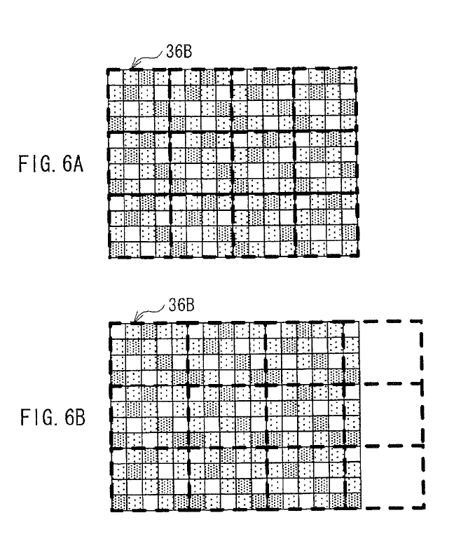

In the first array, the number of columns may be equal to a submultiple of the number of pixel rows in the display panel 10 (refer to FIG. 6A), or may be different from a submultiple of the number of pixel rows in the display panel 10 (refer to FIG. 6B). Moreover, in the first array, the number of rows may be equal to or different from a submultiple of the number of pixel columns in the display panel 10.

In the case where the number of columns in the first array is different from a submultiple of the number of pixel rows in the display panel 10, the unevenness correction circuit 33 does not execute a computation with a correction factor not having a corresponding pixel 14 from among all of the correction factors included in the unevenness correction LUT 36B. Likewise, in the case where the number of rows in the first array is different from a submultiple of the number of pixel columns in the display panel 10, the unevenness correction circuit 33 does not execute a computation with a correction factor not having a corresponding pixel 14 from among all of the correction factors included in the unevenness correction LUT 36B.

Moreover, when all of the correction factors included in the unevenness correction LUT 36B are arranged in a matrix corresponding to the array of the pixels 14 in the display panel 10, the unevenness correction LUT 36B is in a point-symmetrical arrangement. The unevenness correction LUT 36B has regularity of one-fold rotational symmetry or two-fold rotational symmetry. It is to be noted that the unevenness correction LUT 36B may have an array including a combination of two or more arrays of one kind selected from the arrays illustrated in FIGS. 4A to 4G and FIGS. 5A to 5E.

### (Unevenness Correction Circuit 33)

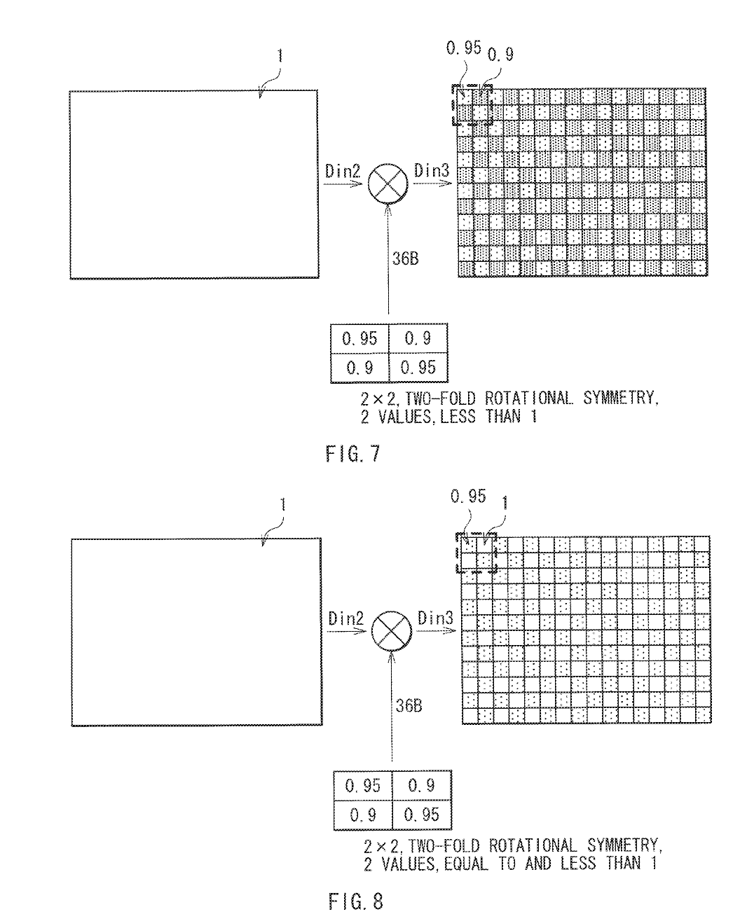

Next, the unevenness correction circuit 33 will be described below. FIGS. 7 to 13 schematically illustrate computations in the unevenness correction circuit 33. A left-side part in each of FIGS. 7 to 13 illustrates that the image signal Din2 input into the unevenness correction circuit 33 is an image signal corresponding to a white display state.

Moreover, a middle part in each of FIGS. 7 to 13 illustrates that the image signal Din2 input into the unevenness correction circuit 33 is multiplied by the unevenness correction LUT 36B. In this case, as described above, the unevenness correction LUT 36B includes correction factors which are smaller in number than all pixels in the display panel 10. Therefore, the unevenness correction circuit 33 sequentially multiplies gradation signals corresponding to all pixels in the display panel 10 by the unevenness correction LUT 36B in groups of gradation signals which are equal in number to the correction factors included in the unevenness correction LUT 36B without collectively multiplying all of the gradation signals.

Moreover, a right-side part in each of FIGS. 7 to 13 illustrates that an image generated by the image signal Din3 output from the unevenness correction circuit 33 has a striped pattern. It is to be noted that a display image is generated by not the unevenness correction circuit 33 but the display panel 10. Although a noise-like pattern with regularity is clearly illustrated in the image generated based on the image signal Din3, this noise-like pattern is exaggeratedly illustrated, and in an actual image, the level of luminance of a noise-like pattern with regularity is the same as that of luminance of a plurality of stripes caused by the display panel 10 (refer to a left-side part in FIG. 14).

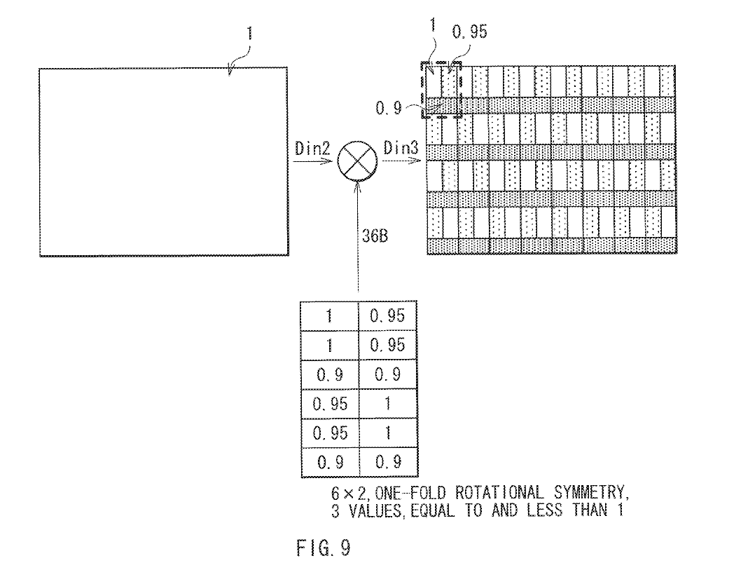

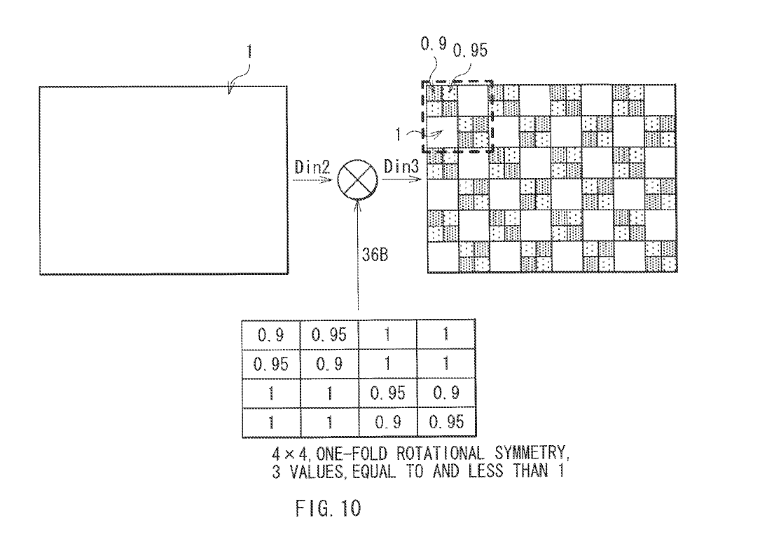

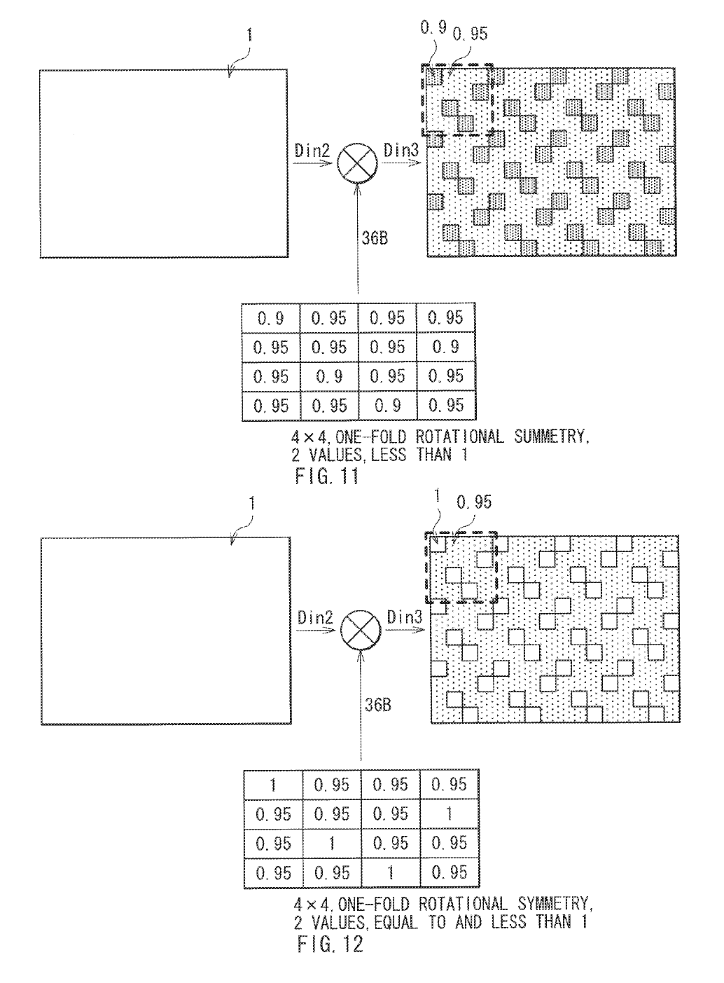

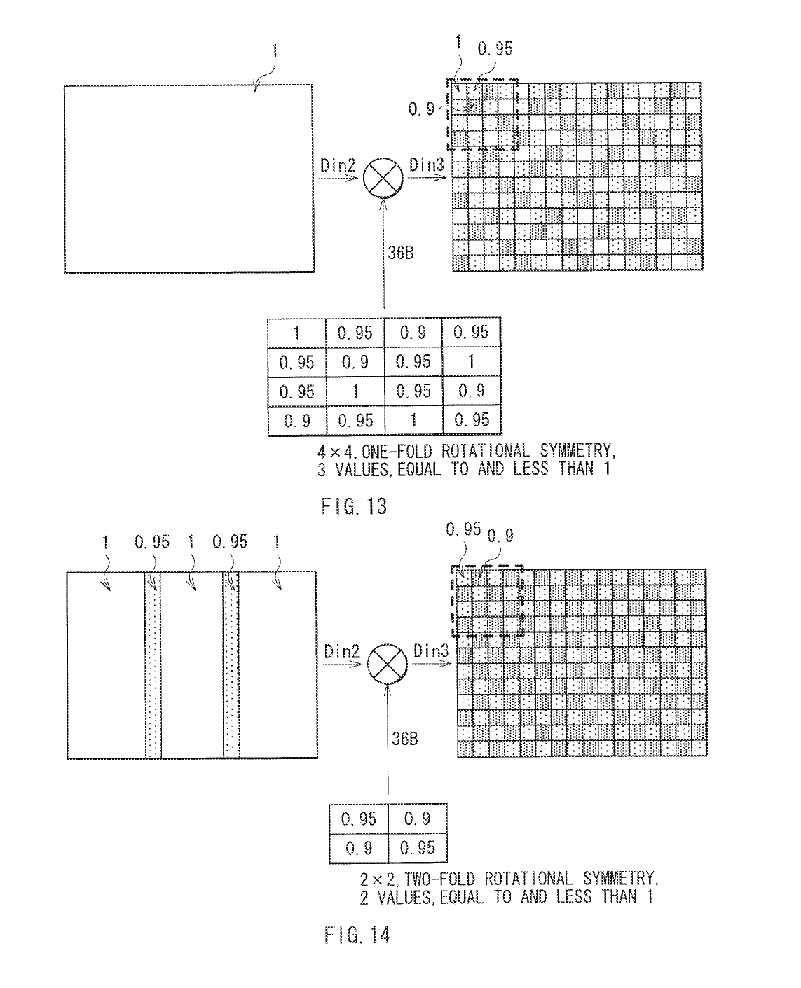

It is to be noted that, in FIG. 7, the unevenness correction LUT 36B illustrated in FIG. 4A is used. In FIG. 8, the unevenness correction LUT 36B illustrated in FIG. 4B is used. In FIG. 9, the unevenness correction LUT 36B illustrated in FIG. 4C is used. In FIG. 10, the unevenness correction LUT 36B illustrated in FIG. 4D is used. In FIG. 11, the unevenness correction LUT 36B illustrated in FIG. 4E is used. In FIG. 12, the unevenness correction LUT 36B illustrated in FIG. 4F is used. In FIG. 13, the unevenness correction LUT 36B illustrated in FIG. 4G is used.

The unevenness correction circuit 33 performs a correction on the image signal Din2 (a first image signal) so as to generate a noise-like pattern with regularity in an image, and thereby to generate the image signal Din3 (a second image signal). More specifically, the unevenness correction circuit 33 performs a correction on the image signal Din2 so as to generate, as a noise-like pattern, a pattern formed in an image through repeating a sub-pattern in a first direction in a plane of the image and a second direction intersecting with the first direction, and thereby to generate the image signal Din3.

After the normalization circuit 32 normalizes the image signal Din1, the unevenness correction circuit 33 performs a correction on the image signal Din2 obtained through normalizing the image signal Dint in the above-described manner (that is, so as to generate the noise-like pattern with regularity in an image) to generate the image signal Din3. In this case, the image signal Din2 includes gradation signals which are equal in number to all pixels in the display panel 10. At this time, the unevenness correction circuit 33 performs the above-described correction (hereinafter referred to as “unevenness correction”) on the gradation signals included in the image signal Din2 with use of the unevenness correction LUT 36B including correction factors which are smaller in number than all pixels in the display panel 10. In other words, the unevenness correction LUT 36B is a low-bit LUT.

For example, the unevenness correction circuit 33 sequentially performs the above-described correction on the gradation signals included in the image signal Din2 in groups of gradation signals which are equal in number to the correction factors included in the unevenness correction LUT 36B. The above-described correction on the gradation signals included in the image signal Din2 refers to multiplying the gradation signals included in the image signal Din2 by the correction factors included in the unevenness correction LUT 36B. As a result, as illustrated in FIGS. 7 to 13, a noise-like pattern with regularity is generated in an image corresponding to the image signal Din3. When luminance in a white display state around the pattern is 1, luminance of the noise-like pattern with regularity may be, for example, 0.95 or 0.9.

FIG. 14 schematically illustrates another example of the computation in the unevenness correction circuit 33. A left-side part in FIG. 14 illustrates that the image signal Din2 input into the uneven correction circuit 33 is an image signal which allows a plurality of stripes to appear in a white display state. It is to be noted that FIG. 14 illustrates the unevenness correction LUT 36B illustrated in FIG. 4A; however, the unevenness correction LUT 36B used herein is not limited to the unevenness correction LUT 36B illustrated in FIG. 4A. Moreover, a plurality of stripes in a display image are slightly visible when the stripes appear in the white display state.

The unevenness correction circuit 33 performs a correction on the image signal Din2 so as to generate a noise-like pattern with regularity in an image irrespective of the magnitude or distribution of gradation of the image signal Din2, and thereby to generate the image signal Din3. After the normalization circuit 32 normalizes the image signal Din1, the unevenness correction circuit 33 further performs the above-described correction on the image signal Din2 obtained through normalizing the image signal Din1 irrespective of the magnitude or distribution of gradation of the image signal Din2 to generate the image signal Din3.

In this case, the image signal Din2 includes gradation signals which are equal in number to all pixels in the display panel 10. At this time, the unevenness correction circuit 33 performs the above-described correction on the gradation signals included in the image signal Din2 with use of the unevenness correction LUT 36B including correction factors which are smaller in number than all pixels in the display panel 10. For example, the unevenness correction circuit 33 sequentially performs the above-described correction on the gradation signals included in the image signal Din2 in groups of gradation signals which are equal in number to the correction factors included in the unevenness correction LUT 36B. The above-described correction on the gradation signals included in the image signal Din2 refers to multiplying the gradation signals included in the image signal Din2 by the correction factors included in the unevenness correction LUT 36B.

As a result, as illustrated in FIG. 14, a noise-like pattern with regularity is generated in an image corresponding to the image signal Din3. In other words, the noise-like pattern with regularity is superimposed on an image in which a plurality of stripes appear in a white display state. Therefore, luminance of the plurality of stripes in a display image is nonuniformly reduced by the noise-like pattern with regularity, and luminance of a portion other than the plurality of stripes in the display image is also nonuniformly reduced by the noise-like pattern with regularity. It is to be noted that, in the case where a value greater than 1 is used as a correction factor, the luminance of the plurality of stripes in the display image is nonuniformly reduced and nonuniformly increased by the noise-like pattern with regularity. In other words, the image in which the plurality of stripes appear in the white display state is disturbed (disrupted) by the noise-like pattern with regularity (noise). As a result, the plurality of stripes in the display image are integrated into the noise-like pattern with regularity; therefore, the plurality of stripes in the display image is hardly visible.

Now, configurations (the timing generation circuit 40 and the driver 50) other than the signal processing circuit 30 will be described below.

### (Timing Generation Circuit 40)

The timing generation circuit 40 generates a timing pulse TP, which is a timing pulse for driving the liquid crystal display panel 10 and for controlling horizontal and vertical write transfer, based on a horizontal synchronization signal and a vertical synchronization signal included in a control signal Tin. The timing generation circuit 40 outputs the generated timing pulse TP to the liquid crystal display panel 10 at a predetermined timing. The timing generation circuit 40 generates, as the timing pulse TP, for example, a horizontal start pulse for instructing a start of horizontal scanning, a horizontal clock as a reference of the horizontal scanning, a vertical start pulse for instructing a start of vertical scanning, and a vertical clock as a reference of the horizontal scanning. The timing generation circuit 40 generates a clock CLK for the driver 50, and outputs the clock CLK to the driver 50.

### (Driver 50)

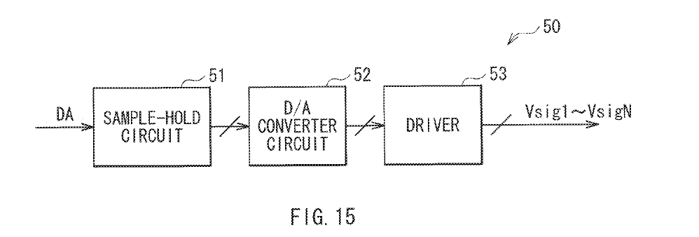

FIG. 15 illustrates functional blocks of the driver 50. The driver 50 includes, for example, a sample-hold circuit 51, a D/A converter circuit 52, and a driver circuit 53. The sample-hold circuit 51 parallelizes the serial-digital image signal DA into a plurality of parallel image signals. The sample-hold circuit 51 outputs phase-expanded image signals to the D/A converter circuit 52 at a timing based on the clock CLK from the timing generation circuit 40. The D/A converter circuit 52 converts the image signals input from the sample-hole circuit 51 (the phase-expanded image signals) into analog signals and outputs the analog signals into the driver circuit 53. A range of a voltage output from the D/A converter circuit 52 to the driver circuit 53 corresponds to an effective voltage range of the display panel 10. In other words, the D/A converter circuit 52 defines the effective voltage range of the display panel 10. The driver circuit 53 inverts analog image signals into AC image signals at a predetermined timing based on the clock CLK output from the timing generation circuit 40, and applies the AC image signals as the image signals Vsig1 to VsigN to the display panel 10.

### [Operation]

Next, operation of the display unit 1 (in particular, operation of the signal processing circuit 30) will be described below.

When the image signal Din is input from outside, the linear γ converter circuit 31 converts the γ characteristic of the image signal Din into a linear γ characteristic with use of the linear γ correction LUT 36A, and outputs the image signal with the linear γ characteristic as the image signal Din1. Next, the normalization circuit 32 outputs the image signal Din2 obtained through normalizing the image signal Din1. Next, the unevenness correction circuit 33 performs a correction on gradation signals included in the image signal Din2 with use of the unevenness correction LUT 36B including correction factors which are smaller in number than all pixels in the display panel 10. More specifically, the unevenness correction circuit 33 sequentially multiplies the gradation signals corresponding to all pixels in the display panel 10 in groups of gradation signals which are equal in number to the correction factors included in the unevenness correction LUT 36B. After that, the unevenness correction circuit 33 outputs the image signal Din3 obtained by the above-described correction.

Next, the gradation circuit 34 provides gradation information suitable for the D/A converter circuit 52 in a stage following the gradation circuit 34 to the image signal Din3. More specifically, the gradation circuit 34 multiplies the image signal Din3 by all correction factors included in the unevenness correction LUT 36B to obtain the image signal Din4, and outputs the image signal Din4. The panel γ converter circuit 35 converts the image signal Din4 into the image signal DA with use of the γ correction LUT 36C. More specifically, the panel γ converter circuit 35 converts the linear γ characteristic of the image signal Din4 into a γ characteristic complementary to the γ characteristic of the display panel 10 with use of the γ correction LUT 36C, and outputs, as the image signal DA, an image signal with a γ characteristic complementary to the γ characteristic of the display panel 10.

### [Effects]

Next, effects of the display unit 1 will be described below. In the display unit 1, a correction is performed on the image signal Din2 so as to generate a noise-like pattern with regularity in an image, and thereby to generate the image signal Din3. Therefore, even if stripes or luminance unevenness is caused in a display image in the case where the image signal Din2 is input into the display panel 10, a pattern making the stripes or the luminance unevenness less visible is allowed to be superimposed on the display image. Moreover, in an embodiment of the disclosure, the pattern superimposed on the display image is a noise-like pattern with regularity, and is a pattern obtained without measuring light emission characteristics of the display panel 10. Therefore, it is not necessary to measure the light emission characteristics of the display panel 10 to superimpose the above-described pattern on the display image. Thus, display failures such as stripes and luminance unevenness are preventable. Moreover, in the display unit 1, it is not necessary to measure the light emission characteristics of the display panel 10 to superimpose the above-described pattern on the display image; therefore, manufacturing time is less likely to be increased. Therefore, in the embodiment of the disclosure, display failures are preventable without increasing the manufacturing time.

### 2. Modifications

### [Modification 1]

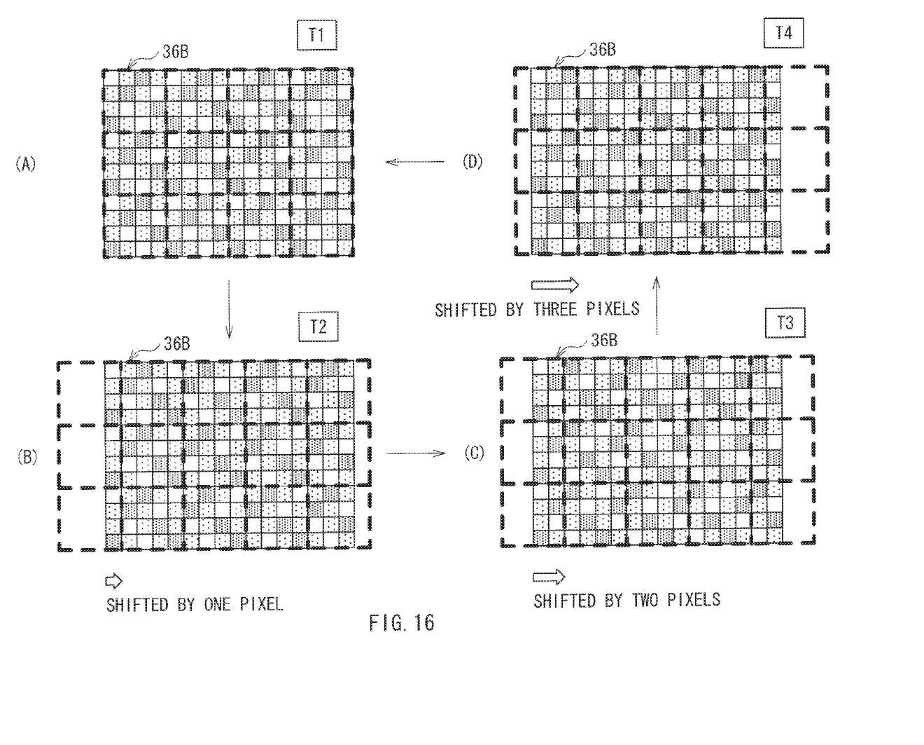

In the above-described embodiment, the unevenness correction circuit 33 sequentially performs an unevenness correction on the gradation signals included in the image signal Din2 in groups of gradation signals which are equal in number to the correction factors included in the unevenness correction LUT 36B. At this time, for example, as illustrated in FIG. 6A or FIG. 6B, the unevenness correction circuit 33 may fix a combination of gradation signals, which are to be collectively subjected to an unevenness correction, of the image signals Din2 irrespective of a lapse of time. Alternatively, the unevenness correction circuit 33 may vary the combination of gradation signals, which are to be collectively subjected to an unevenness correction, of the image signals Din2 at predetermined time intervals. For example, as illustrated in parts (A), (B), (C), and (D) in FIG. 16, the unevenness correction circuit 33 may shift the combination of the gradation signals, which are to be collectively subjected to an unevenness correction, of the image signals Din2 by one pixel in the horizontal direction of the array of the pixels 11 at predetermined time intervals. In such a case, burn-in caused by a pattern formed by the application of the unevenness correction LUT 36B is preventable.

### [Modification 2]

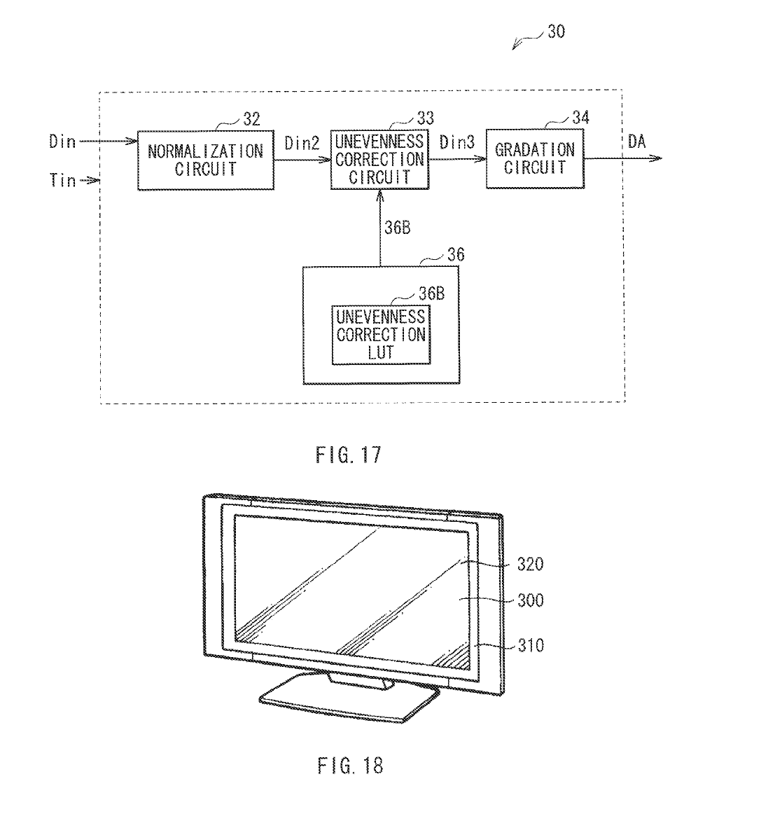

In the above-described embodiment, the signal processing circuit 30 includes the linear γ converter circuit 31 and the γ converter circuit 35; however, for example, as illustrated in FIG. 17, these circuits may not be included. In other words, the signal processing circuit 30 may perform an unevenness correction on the image signal Din which has been subjected to the predetermined γ correction and has not been subjected to normalization.

### 3. Application Examples

Next, application examples of the display units 1 according to the above-described embodiment and the modifications thereof (hereinafter referred to as “the above-described embodiment and the like”) will be described below. The display units 1 according to the above-described embodiment and the like are applicable to display units of electronic apparatuses, in any fields, which display an image signal supplied from outside or an image signal produced inside as an image or a picture, such as televisions, digital cameras, notebook personal computers, portable terminal units such as cellular phones, and video cameras.

### Application Example 1

FIG. 18 illustrates an appearance of a television to which any one of the display units 1 according to the above-described embodiment and the like is applied. The television includes, for example, an image display screen section 300 including a front panel 310 and a filter glass 320, and the image display screen section 300 is configured of any one of the display units 1 according to the above-described embodiment and the like.

### Application Example 2

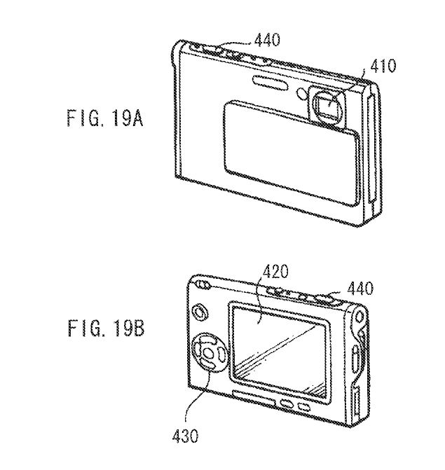

FIGS. 19A and 19B illustrate an appearance of a digital camera to which any one of the display units 1 according to the above-described embodiment and the like is applied. The digital camera includes, for example, a light-emitting section 410 for a flash, a display section 420, a menu switch 430, and a shutter button 440, and the display section 420 is configured of any one of the display units 1 according to the above-described embodiment and the like.

### Application Example 3

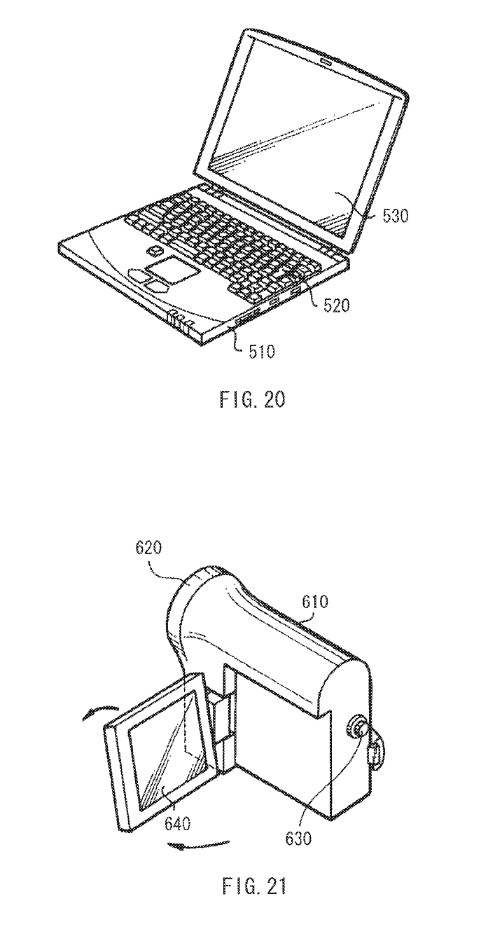

FIG. 20 illustrates an appearance of a notebook personal computer to which any one of the display units 1 according to the above-described embodiment and the like is applied. The notebook personal computer includes, for example, a main body 510, a keyboard 520 for operation of inputting characters and the like, and a display section 530 for displaying an image, and the display section 530 is configured of any one of the display units 1 according to the above-described embodiment and the like.

### Application Example 4

FIG. 21 illustrates an appearance of a video camera to which any one of the display units 1 according to the above-described embodiment and the like is applied. The video camera includes, for example, a main body 610, a lens 620 provided on a front surface of the main body 610 and for shooting an image of an object, a shooting start/stop switch 630, and a display section 640, and the display section 640 is configured of any one of the display units 1 according to the above-described embodiment and the like.

### Application Example 5

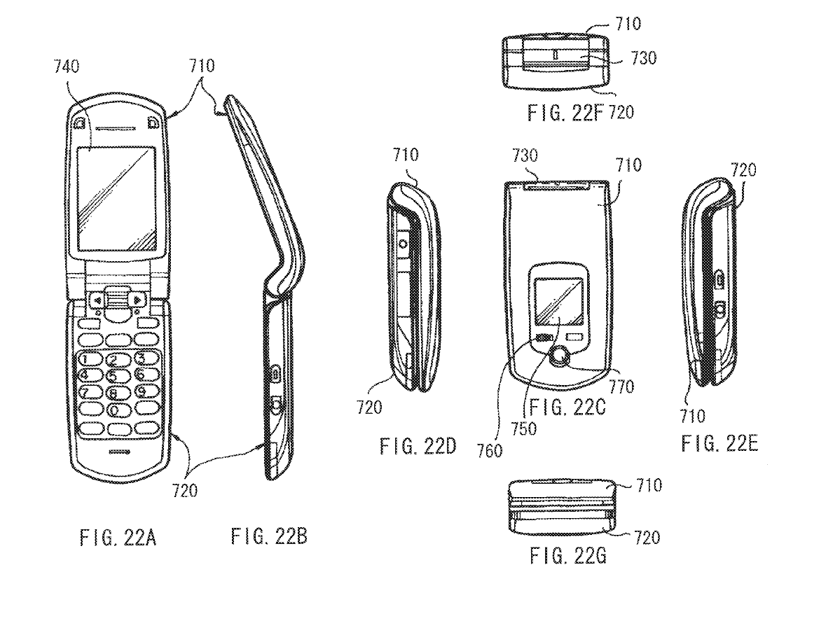

FIGS. 22A to 22G illustrate an appearance of a cellular phone to which any one of the display units 1 according to the above-described embodiment and the like is applied. The cellular phone has a configuration in which, for example, a top-side enclosure 710 and a bottom-side enclosure 720 are connected together through a connection section (hinge section) 730, and the cellular phone includes a display 740, a sub-display 750, a picture light 760, and a camera 770. The display 740 or the sub-display 750 is configured of any one of the display units 1 according to the above-described embodiment and the like.

Although the present disclosure is described referring to some embodiments and the application examples, the disclosure is not limited thereto, and may be variously modified.

For example, in the above-described embodiment and the like, the signal processing circuit 30 may be configured of hardware (a circuit) or software (a program).

Moreover, in the above-described embodiment and the like, a case where the display unit 1 is an organic EL display unit is described as an example; however, the display unit 1 may be an LED display unit in which a plurality of LEDs of the order of μm are arranged in a matrix as display pixels. Also in the LED display unit, LED characteristics may vary from one LED to another, and in this case, stripes or luminance unevenness may be caused in a display image. Therefore, the technology of the disclosure is also effective in the LED display unit.

It is to be noted that the technology is allowed to have the following configurations.

(1) A drive circuit for driving a display panel comprising:

a driver; and

a signal processing circuit configured to receive an image signal and to output a corrected image signal to the driver, the signal processing circuit including

an unevenness correction circuit configured to sequentially multiply gradation signals included in the image signal by correction factors, the correction factors corresponding to a repeated array of pixels in the display panel.

(2) The drive circuit for driving the display panel according to (1), wherein the repeated array of pixels is a regularly repeated array of pixels.

(3) The drive circuit for driving the display panel according to (2), wherein the regularly repeated array of pixels is arranged in a checkered pattern having M rows and N columns, where M and N are integers that are at least 2.

(4) The drive circuit for driving the display panel according to (3), wherein the correction factors have values that are equal to or less than 1.

(5) An electronic apparatus having a drive circuit for driving a display panel comprising:

a driver; and

a signal processing circuit configured to receive an image signal and to output a corrected image signal to the driver, the signal processing circuit including

an unevenness correction circuit configured to sequentially multiply gradation signals included in the image signal by correction factors, the correction factors corresponding to a repeated array of pixels in the display panel.

(6) The electronic apparatus according to (5), wherein the repeated array of pixels is a regularly repeated array of pixels.

(7) The electronic apparatus according to (6), wherein the regularly repeated array of pixels is arranged in a checkered pattern having M rows and N columns, where M and N are integers that are at least 2.

(8) The electronic apparatus according to (7), wherein the correction factors have values that are equal to or less than 1.

(9) A signal processing circuit comprising:

a linear gamma converter circuit configured to convert a gamma characteristic of an image signal into a linear gamma characteristic; and

an unevenness correction circuit configured to receive a converted image signal from the linear gamma converter circuit and to sequentially multiply gradation signals included in the converted image signal by correction factors, the correction factors corresponding to a repeated array of pixels in the display panel.

(10) The signal processing circuit according to (9), wherein the repeated array of pixels is a regularly repeated array of pixels.

(11) The signal processing circuit according to (10), wherein the regularly repeated array of pixels is arranged in a checkered pattern having M rows and N columns, where M and N are integers that are at least 2.

(12) The signal processing circuit according to (11), wherein the correction factors have values that are equal to or less than 1.

(13) A method of processing an image signal to be supplied to a display panel, the method comprising:

converting a gamma characteristic of the image signal into a linear gamma characteristic; and

multiplying gradation signals included in a converted image signal by correction factors, the correction factors corresponding to a repeated array of pixels in the display panel.

(14) The method of processing the image signal according to (13), wherein the repeated array of pixels is a regularly repeated array of pixels.

(15) The method of processing the image signal according to (14), further comprising arranging the regularly repeated array of pixels in a checkered pattern having M rows and N columns, where M and N are integers that are at least 2.

(16) The method of processing the image signal according to (15), wherein the correction factors have values that are equal to or less than 1.

(17) A signal processing circuit performing a correction on a first image signal to generate a noise-like pattern with regularity in an image, and thereby to generate a second image signal.

(18) The signal processing circuit according to (17), in which a correction is performed on the first image signal to generate, as the noise-like pattern, a pattern formed through repeatedly arranging a sub-pattern in a first direction in a plane of the image and a second direction intersecting with the first direction, and thereby to generate the second image signal.

(19) The signal processing circuit according to (17) or (18), in which

the correction is performed to allow contrast of the noise-like pattern to be equal to, substantially equal to, or lower than contrast of a striped pattern caused by characteristics of a display panel.

(20) The signal processing circuit according to any one of (17) to (19), in which the first image signal is normalized, and then the correction is performed on the normalized first image signal to generate the second image signal.

(21) The signal processing circuit according to (20), in which

the first image signal includes gradation signals which are equal in number to pixels in a display panel, and

the signal processing circuit performs the correction on the gradation signals included in the first image signal with use of a look-up table including correction factors which are smaller in number than all pixels in the display panel.

(22) The image processing circuit according to (21), in which the correction on the gradation signals included in the first image signal is sequentially performed in groups of gradation signals which are equal in number to the correction factors included in the look-up table.

(23) The signal processing circuit according to (21) or (22), in which a combination of two or more gradation signals, which are to be collectively subjected to the correction, of the gradation signals changes at predetermined time intervals.

(24) The signal processing circuit according to any one of (21) to (23), in which an array of the look-up table is in one-fold rotational symmetry or two-fold rotational symmetry when all correction factors included in the look-up table are arranged in a matrix corresponding to an array of the pixels in the display panel.

(25) The signal processing circuit according to any one of (21) to (24), in which the look-up table includes, as the correction factors, 1 and an integer greater than 1 selected from among an integer less than 1, 1, and the integer greater than 1.

(26) The signal processing circuit according to any one of (17) to (25), wherein

the first image signal is an image signal subjected to a predetermined gamma correction, and

the signal processing circuit cancels the gamma correction applied to the first image signal to generate a third image signal with a linear gamma characteristic.

(27) The signal processing circuit according to (26), wherein the third image signal is normalized, and then the correction is performed on the normalized third image signal to generate the second image signal.

(28) A display unit provided with a display panel and a drive circuit driving the display panel, the drive circuit including:

a signal processing circuit performing a correction on a first image signal to generate a noise-like pattern with regularity in an image, and thereby to generate a second image signal.

(29) An electronic apparatus provided with a display unit, the display unit including a display panel and a drive circuit driving the display panel, the drive circuit including:

a signal processing circuit performing a correction on a first image signal to generate a noise-like pattern with regularity in an image, and thereby to generate a second image signal.

(30) A signal processing method including:

performing a correction on a first image signal to generate a noise-like pattern with regularity in an image, and thereby to generate a second image signal.

The disclosure contains subject matter related to that disclosed in Japanese Priority Patent Application No. 2012-170369 filed in the Japan Patent Office on Jul. 31, 2012, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A drive circuit for driving a display panel comprising:
a driver; and
a signal processing circuit configured to receive an image signal and to output a corrected image signal to the driver, the signal processing circuit including
an unevenness correction circuit configured to sequentially multiply gradation signals included in the image signal by correction factors, the correction factors corresponding to a repeated array of pixels in the display panel.

2. The drive circuit for driving the display panel according to claim 1, wherein the repeated array of pixels is a regularly repeated array of pixels.

3. The drive circuit for driving the display panel according to claim 2, wherein the regularly repeated array of pixels is arranged in a checkered pattern having M rows and N columns, where M and N are integers that are at least 2.

4. The drive circuit for driving the display panel according to claim 3, wherein the correction factors have values that are equal to or less than 1.

5. An electronic apparatus having a drive circuit for driving a display panel comprising:
a driver; and
a signal processing circuit configured to receive an image signal and to output a corrected image signal to the driver, the signal processing circuit including
an unevenness correction circuit configured to sequentially multiply gradation signals included in the image signal by correction factors, the correction factors corresponding to a repeated array of pixels in the display panel.

6. The electronic apparatus according to claim 5, wherein the repeated array of pixels is a regularly repeated array of pixels.

7. The electronic apparatus according to claim 6, wherein the regularly repeated array of pixels is arranged in a checkered pattern having M rows and N columns, where M and N are integers that are at least 2.

8. The electronic apparatus according to claim 7, wherein the correction factors have values that are equal to or less than 1.

9. A signal processing circuit comprising:
a linear gamma converter circuit configured to convert a gamma characteristic of an image signal into a linear gamma characteristic; and
an unevenness correction circuit configured to receive a converted image signal from the linear gamma converter circuit and to sequentially multiply gradation signals included in the converted image signal by correction factors, the correction factors corresponding to a repeated array of pixels in the display panel.

10. The signal processing circuit according to claim 9, wherein the repeated array of pixels is a regularly repeated array of pixels.

11. The signal processing circuit according to claim 10, wherein the regularly repeated array of pixels is arranged in a checkered pattern having M rows and N columns, where M and N are integers that are at least 2.

12. The signal processing circuit according to claim 11, wherein the correction factors have values that are equal to or less than 1.

13. A method of processing an image signal to be supplied to a display panel, the method comprising:
converting a gamma characteristic of the image signal into a linear gamma characteristic; and
multiplying gradation signals included in a converted image signal by correction factors, the correction factors corresponding to a repeated array of pixels in the display panel.

14. The method of processing the image signal according to claim 13, wherein the repeated array of pixels is a regularly repeated array of pixels.

15. The method of processing the image signal according to claim 14, further comprising arranging the regularly repeated array of pixels in a checkered pattern having M rows and N columns, where M and N are integers that are at least 2.

16. The method of processing the image signal according to claim 15, wherein the correction factors have values that are equal to or less than 1.
